(19) United States
(12) Patent Application Publication
(10) Pub. No.: US 2021/0162353 A1
(43) Pub. Date: Jun. 3, 2021

(54) MIXED MATRIX MEMBRANE WITH GRAPHENE OXIDE AND POLYETHER AMIDE POLYMER FOR DEHYDRATION OF GAS

(71) Applicant: NITTO DENKO CORPORATION, Osaka (JP)

(72) Inventors: Shijun Zheng, San Diego, CA (US); Weiping LIN, Carlsbad, CA (US); Peng Wang, San Diego, CA (US); Isamu Kitahara, San Diego, CA (US); Bita Bagge, Vista, CA (US); John Ericson, Poway, CA (US); Wanyun Hsieh, San Diego, CA (US); Yuji Yamashiro, Osaka (JP); Takashi Kondo, Osaka (JP)

(21) Appl. No.: 17/044,941

(22) PCT Filed: Apr. 3, 2019
(86) PCT No.: PCT/US2019/025520

§ 371 Date: Oct. 2, 2020

Related U.S. Application Data
(60) Provisional application No. 62/714,504, filed on Aug. 3, 2018.
(60) Provisional application No. 62/734,706, filed on Sep. 21, 2018.

(51) Int. Cl. B01D 69/14; B01D 69/10; B01D 69/12; B01D 69/02; B01D 71/02; B01D 71/80; B01D 71/62; B01D 71/66; B01D 53/22; B01D 53/26; B01D 67/00; F24F 3/14

(52) U.S. Cl. CPC B01D 69/148; F24F 2003/1435; B01D 69/125; B01D 69/02; B01D 71/024; B01D 71/80; B01D 71/62; B01D 71/66; B01D 53/228; B01D 53/268; B01D 67/0079; B01D 71/021; F24F 3/14; B01D 2325/34; B01D 2325/04; B01D 2325/20; B01D 2325/48; B01D 2323/30; B01D 69/10

(57) ABSTRACT

Described herein are crosslinked graphene oxide based composite membranes that provide selective resistance for gases while providing water vapor permeability. Such composite membranes have a high water/air selectivity in permeability. The methods for making such membranes, and using the membranes for dehydrating or removing water vapor from gases are also described.

### CROSS-REFERENCE TO RELATED APPLICATIONS

This application claims the benefit of U.S. Provisional Application No. 62/714,504, filed Aug. 3, 2018; and U.S. Provisional Application No. 62/734,706, filed Sep. 21, 2018; this application is also a continuation-in-part of international application of PCT/US2018/026283, filed Apr. 5, 2018, all of which are incorporated by reference by their entireties.

### FIELD

The present embodiments are related to polymeric membranes, including membranes comprising graphene materials for applications such as removing water or water vapor from air or other gas streams and energy recovery ventilation (ERV).

### BACKGROUND

The presence of a high moisture level in the air may make people uncomfortable, and also may cause serious health issues by promoting growth of mold, fungus, as well as dust mites. In manufacturing and storage facilities, high humidity environments may accelerate product degradation, powder agglomeration, seed germination, corrosion, and other undesired effects, which is a concern for chemical, pharmaceutical, food and electronic industries. One of the conventional methods to dehydrate air includes passing wet air through hydroscopic agents, such as glycol, silica gel, molecular sieves, calcium chloride, and phosphorus pentaoxide. This method has many disadvantages, for example, the drying agent has to be carried over in a dry air stream; and the drying agent also requires a replacement or regeneration over time, which makes the dehydration process costly and time consuming. Another conventional method of dehydration of air is cryogenic method by compressing and cooling the wet air to condense moisture followed by removing the condensed water, however, this method is highly energy consuming.

Compared with the conventional dehydration or dehumidification technologies described above, membrane-based gas dehumidification technology has distinct technical and economic advantages, such as low installation cost, easy operation, high energy efficiency and low process cost, as well as high processing capacity. This technology has been successfully applied in dehydration of nitrogen, oxygen, and compressed air. For ERV application, such as inside buildings, it is desirable to provide fresh air from outside, especially in hot and humid climates, where the outside air is much hotter and has more moisture than the air inside the building. Energy is required to cool and dehumidify the fresh air. The amount of energy required for heating or cooling and dehumidification can be reduced by transferring heat and moisture between the exhausting air and the incoming fresh air through an energy recovery ventilator (ERV) system. The ERV system comprises a membrane which separates the exhausting air and the incoming fresh air physically, but allows the heat and moisture exchange. The required key characteristics of the ERV membrane include: (1) low permeability of air and gases other than water vapors; and (2) high permeability of water vapor for effective transfer of moisture between the incoming and the outgoing air stream while blocking the passage of other gases; and (3) high thermal conductivity for effective heat transfer.

There is a need of membranes with high permeability of water vapor and low permeability of air for ERV application.

### SUMMARY

The disclosure relates to a graphene oxide (GO) membrane composition which may reduce water swelling and increase selectivity of H₂O/air permeability. Some membranes may provide improved dehydration as compared to traditional polymers, such as polyvinyl alcohols (PVA), poly(acrylic acid) (PAA), and polyether ether ketone (PEEK). The GO membrane composition may be prepared by using one or more water soluble cross-linkers. Methods of efficiently and economically making these GO membrane compositions are also described. Water can be used as a solvent in preparing these GO membrane compositions, which makes the membrane preparation process more environmentally friendly and more cost effective.

Some embodiments include a dehydration membrane comprising: a porous support; and a composite coated on the porous support comprising a crosslinked graphene oxide compound. The crosslinked graphene oxide compound is formed by reacting a mixture comprising 1) a graphene oxide compound, and 2) a polyether block amide (PEBA), a poly(diallyldimethylammonium chloride)(PDADMA), a poly(acrylamide-co-diallyldimethylammonium chloride)(PACD), a poly(sodium 4-styrenesulfonate)(PSS), or a combination thereof.

Some embodiments include a method for dehydrating a gas comprising: applying a first gas to a dehydration membrane described herein; allowing the water vapor to pass through the dehydration membrane and to be removed; and generating a second gas that has lower water vapor content than the first gas.

Some embodiments include a method of making a dehydration membrane comprising: curing an aqueous mixture that is coated onto a porous support; wherein the aqueous mixture that is coated onto the porous support is cured at a temperature of 60° C. to 100° C. for about 30 seconds to about 3 hours to facilitate crosslinking within the aqueous mixture; wherein the porous support is coated with the aqueous mixture by applying the aqueous mixture to the porous support and repeating as necessary to achieve a layer of coating having a thickness of about 100 nm to about 4000 nm; and wherein the aqueous mixture is formed by mixing 1) a graphene oxide compound, and 2) a PEBA, a PDADMA, a PACD, a PSS, or a combination thereof, in an aqueous liquid. In some embodiments, the aqueous liquid comprises a solvent mixture that contains ethanol and water.

Some embodiments include an energy recovery ventilator system comprising a dehydration membrane described herein.

### BRIEF DESCRIPTION OF THE DRAWINGS

FIG. 1 is a depiction of a possible embodiment of a selective dehydration membrane.

FIG. 2 is a depiction of a possible embodiment for the method/process of making a separation/dehydration membrane element.

### DETAILED DESCRIPTION

A selectively permeable membrane includes a membrane that is relatively permeable to one material and relatively impermeable to another material. For example, a membrane may be relatively permeable to water vapor and relatively impermeable to gases such as oxygen and/or nitrogen. The ratio of permeability for different materials may be useful in describing their selective permeability.

These membranes may also have antimicrobial activity, such as an antimicrobial activity of at least about 1, at least about 2, at least about 3, about 1-2, about 2-3, or about 1-3 according to Japanese Industrial Standard Z 2801:2012. Antimicrobial activity may help to prevent contamination and/or the accumulation of biofilm on the membrane.

### Dehydration Membrane

The present disclosure relates to dehydration membranes having a highly selective hydrophilic GO-based composite material with high water vapor permeability, low gas permeability, and high mechanical and chemical stability. These membranes may be useful in applications where a dry gas or gas with low water vapor content is desired.

In some embodiments, the crosslinked GO-based membranes may comprise multiple layers, wherein at least one layer comprises a composite of a crosslinked graphene oxide (GO), or a GO-based composite. The crosslinked GO-based composite can be prepared by reacting a mixture comprising a graphene oxide compound and a crosslinker. It is believed that a crosslinked GO layer, with graphene oxide's hydrophilicity and selective permeability, may provide the membrane for broad applications where high moisture permeability with low gas permeability is important. In addition, these selectively permeable membranes may also be prepared using water as a solvent, which can make the manufacturing process much more environmentally friendly and cost effective.

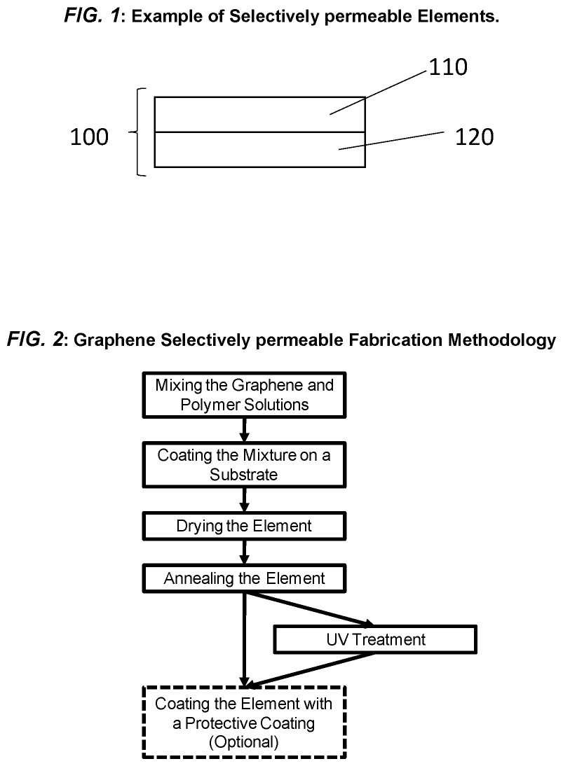

Generally, a dehydration membrane comprises a porous support and a composite coated onto the support. For example, as depicted in FIG. 1, selectively permeable membrane 100 can include porous support 120. Crosslinked GO-based composite 110 is coated onto porous support 120.

In some embodiments, the porous support comprises a polymer or hollow fibers. The porous support may be sandwiched between two composite layers. The crosslinked GO-based composite may further be in fluid communication with the support.

An additional optional layer, such as a protective layer, may also be present. In some embodiments, the protective layer can comprise a hydrophilic polymer. A protective layer may be placed in any position that helps to protect the selectively permeable membrane, such as a water permeable membrane, from harsh environments, such as compounds which may deteriorate the layers, radiation, such as ultraviolet radiation, extreme temperatures, etc.

In some embodiments, the gas passing through the membrane travels through all the components regardless of whether they are in physical communication or their order of arrangement.

A dehydration or water permeable membrane, such as one described herein, can be used to remove moisture from a gas stream. In some embodiments, a membrane may be disposed between a first gas component and a second gas component such that the components are in fluid communication through the membrane. In some embodiments, the first gas may contain a feed gas upstream and/or at the permeable membrane.

In some embodiments, the membrane can selectively allow water vapor to pass through while keeping other gases or a gas mixture, such as air, from passing through. In some embodiments, the membrane can be highly moisture permeable. In some embodiments, the membrane can have low permeability or may not be permeable to a gas or a gas mixture such as N₂ or air. In some embodiments, the membrane may be a dehydration membrane. In some embodiments, the membrane may be an air dehydration membrane. In some embodiments, the membrane may be a gas separation membrane. In some embodiments, a membrane that is moisture permeable and/or gas impermeable barrier membrane containing graphene material, e.g., graphene oxide, may provide desired selectivity between water vapor and other gases. In some embodiments, the selectively permeable membrane may comprise multiple layers, where at least one layer is a layer containing graphene oxide material.

In some embodiments, the moisture permeability may be measured by water vapor transfer rate. In some embodiments, the membrane exhibits a normalized water vapor flow rate of about 500-2000 g/m²/day; about 1000-2000 g/m²/day, about 1000-1500 g/m²/day, about 1500-2000 g/m²/day, about 1000-1700 g/m²/day; about 1200-1500 g/m²/day; about 1300-1500 g/m²/day, at least about 500 g/m²/day, about 500-1000 g/m²/day, about 500-750 g/m²/day, about 750-1000 g/m²/day, about 600-800 g/m²/day, about 800-1000 g/m²/day, about 1000 g/m²/day, about 1200 g/m²/day, about 1300 g/m²·day, or any normalized volumetric water vapor flow rate in a range bounded by any of these values. A suitable method for determining moisture (water vapor) transfer rates is ASTM E96.

### Porous Support

A porous support may be any suitable material and in any suitable form upon which a layer, such as a layer of the composite, may be deposited or disposed. In some embodiments, the porous support can comprise hollow fibers or porous material. In some embodiments, the porous support may comprise a porous material, such as a polymer or a hollow fiber. Some porous supports can comprise a non-woven fabric. In some embodiments, the polymer may be polyamide (Nylon), polyimide (PI), polyvinylidene fluoride (PVDF), polyethylene (PE), stretched PE, polypropylene (including stretched polypropylene), polyethylene terephthalate (PET), polysulfone (PSF), polyether sulfone (PES), cellulose acetate, polyacrylonitrile (e.g. PA200), or a combination thereof. In some embodiments, the polymer can comprise PET. In some embodiments, the polymer comprises polypropylene. In some embodiments, the polymer comprises stretched polypropylene. In some embodiments, the polymer comprises polyethylene. In some embodiments, the polymer comprises stretched polyethylene.

### Composite

The membranes described herein can comprise a composite containing a crosslinked GO compound. Some membranes comprise a porous support and a composite containing the crosslinked GO compound coated on the support. The crosslinked GO compound can be prepared by reacting a mixture comprising a graphene oxide compound and a crosslinker. Suitable crosslinkers may include a PEBA, a PDADMA, a PACD, a PSS, or a combination thereof. Additionally, an additive, a surfactant, a binder, or a combination thereof can also be present in the mixture. The mixture may form covalent bonds, such as crosslinking bonds, between the constituents of the composite (e.g., graphene oxide compound, the crosslinker(s), surfactant, binder, and/or additives). For example, a platelet of a graphene oxide compound may be bonded to another platelet; a graphene oxide compound may be bonded to a crosslinker (such as a PEBA, a PEBA, a PACD, and/or a PSS); a graphene oxide compound may be bonded to an additive; a crosslinker (such as a PEBA, a PDADMA, a PACD, and/or a PSS) may be bonded to an additive, and etc. In some embodiments, any combination of graphene oxide compound, a crosslinker (such as a PEBA, a PDADMA, a PACD, and/or a PSS), a surfactant, a binder, and an additive can be covalently bonded to form a composite. In some embodiments, any combination of graphene oxide compound, a crosslinker (such as a PEBA, a PDADMA, a PACD, and/or a PSS), a surfactant, a binder, and an additive can be physically bonded to form a material matrix.

The mixture comprising the graphene oxide and the crosslinker may include a solvent or solvent mixture, such as an aqueous solvent, e.g. water, optionally in combination with a water soluble organic solvent such as an alcohol (e.g. methanol, ethanol, isopropanol, etc.), acetone, etc. In some embodiments, the aqueous solvent mixture contains ethanol and water.

The crosslinked GO-based composite can have any suitable thickness. For example, some crosslinked GO-based layers may have a thicknesses of about 0.1-5 μm, about 1-3 μm, about 0.1-0.5 μm, about 0.5-1 μm, about 1-1.5 μm, about 1.5-2 μm, about 2-2.5 μm, about 2.5-3 μm, about 3-3.5 μm, about 3.5-4 μm, about 1.5-2.5 μm, about 1.8-2.2 μm, or any thickness in a range bounded by any of these values. Ranges or values above that encompass the following thicknesses are of particular interest: about 2 μm.

### Graphene Oxide

In general, graphene-based materials have many attractive properties, such as a 2-dimensional sheet-like structure with extraordinary high mechanical strength and nanometer scale thickness. Graphene oxide (GO), an exfoliated oxidation product of graphite, can be mass produced at low cost. With its high degree of oxidation, graphene oxide has high water permeability and also exhibits versatility to be functionalized by many functional groups, such as amines or alcohols to form various membrane structures. Unlike traditional membranes, where the water is transported through the pores of the material, in graphene oxide membranes the transportation of water can be between the interlayer spaces. GO's capillary effect can result in long water slip lengths that offer a fast water transportation rate. Additionally, the membrane's selectivity and water flux can be controlled by adjusting the interlayer distance of graphene sheets, or by the utilization of different crosslinking moieties.

In the membranes disclosed, a GO compound includes an optionally substituted graphene oxide. In some embodiments, the optionally substituted graphene oxide may contain a graphene which has been chemically modified, or functionalized. A modified graphene may be any graphene material that has been chemically modified, or functionalized. In some embodiments, the graphene oxide can be optionally substituted.

Functionalized graphene is a graphene oxide compound that includes one or more functional groups not present in graphene oxide, such as functional groups that are not OH, COOH, or an epoxide group directly attached to a C-atom of the graphene base. Examples of functional groups that may be present in functionalized graphene include halogen, alkene, alkyne, cyano, ester, amide, or amine.

In some embodiments, at least about 99%, at least about 95%, at least about 90%, at least about 80%, at least about 70%, at least about 60%, at least about 50%, at least about 40%, at least about 30%, at least about 20%, at least about 10%, or at least about 5% of the graphene molecules in a graphene oxide compound may be oxidized or functionalized. In some embodiments, the graphene oxide compound is graphene oxide, which may provide selective permeability for gases, fluids, and/or vapors. In some embodiments, the graphene oxide compound can also include reduced graphene oxide. In some embodiments, the graphene oxide compound can be graphene oxide, reduced-graphene oxide, functionalized graphene oxide, or functionalized and reduced-graphene oxide. In some embodiments, the graphene oxide compound is graphene oxide that is not functionalized.

It is believed that there may be a large number (^{˜}30%) of epoxy groups on GO, which may be readily reactive with hydroxyl groups at elevated temperatures. It is also believed that GO sheets have an extraordinary high aspect ratio which provides a large available gas/water diffusion surface as compared to other materials, and it has the ability to decrease the effective pore diameter of any substrate supporting material to minimize contaminant infusion while retaining flux rates. It is also believed that the epoxy or hydroxyl groups increases the hydrophilicity of the materials, and thus contributes to the increase in water vapor permeability and selectivity of the membrane.

In some embodiments, the optionally substituted graphene oxide may be in the form of sheets, planes or flakes. In some embodiments, the graphene material may have a surface area of about 100-5000 m²/g, about 150-4000 m²/g, about 200-1000 m²/g, about 500-1000 m²/g, about 1000-2500 m²/g, about 2000-3000 m²/g, about 100-500 m²/g, about 400-500 m²/g, or any surface area in a range bounded by any of these values.

In some embodiments, the graphene oxide may be platelets having 1, 2, or 3 dimensions with size of each dimension independently in the nanometer to micron range. In some embodiments, the graphene may have a platelet size in any one of the dimensions, or may have a square root of the area of the largest surface of the platelet, of about 0.05-100 μm, about 0.05-50 μm, about 0.1-50 μm, about 0.5-10 μm, about 1-5 μm, about 0.1-2 μm, about 1-3 μm, about 2-4 μm, about 3-5 μm, about 4-6 μm, about 5-7 μm, about 6-8 μm, about 7-10 μm, about 10-15 μm, about 15-20 μm, about 50-100 μm, about 60-80 μm, about 50-60 μm, about 25-50 μm, or any platelet size in a range bounded by any of these values.

In some embodiments, the GO material can comprise at least 70%, at least 75%, at least 80%, at least 85%, at least 90%, at least 95%, at least 97%, or at least 99% of graphene material having a molecular weight of about 5,000 Daltons to about 200,000 Daltons.

In some embodiments, the weight percentage of the graphene oxide relative to the total weight of the composite can be about 0.4-0.5%, about 0.5-0.6%, about 0.6-0.7%, about 0.7-0.8%, about 0.8-0.9%, about 0.9-1%, about 1-1.1%, about 1.1-1.2%, about 1.2-1.3%, about 1.3-1.4%, about 1.4-1.5%, about 0.7-0.75%, about 0.75-0.8%, about 0.8-0.85%, about 0.85-0.9%, about 0.9-0.95%, about 0.95-1%, about 1-1.05%, about 0.4%, about 0.5%, about 0.6%, about 0.7%, about 0.8%, about 0.9%, about 0.95%, about 1%, or any weight percentage in a range bounded by any of these values.

### Crosslinker

The composite, such as a crosslinked GO-based composite, is formed by reacting a mixture containing a graphene oxide compound with a crosslinker, such as a PEBA, a PDADMA, a PACD, a PSS, or a combination thereof.

In some embodiments, the crosslinker is a PEBA. In some embodiments, the PEBA is a PEBAX® branded PEBA. In some embodiments, the PEBA is PEBAX® 1657.

Any suitable amount of a PEBA may be used. In some embodiments, the ratio of GO to the PEBA is about 0.005-0.1 (0.5 mg of GO and 100 mg of the PEBA is a ratio of 0.005), 0.001-0.002, about 0.002-0.003, about 0.003-0.004, about 0.004-0.005, about 0.005-0.006, about 0.006-0.007, about 0.007-0.008, about 0.008-0.009, about 0.009-0.01, about 0.01-0.011, about 0.011-0.012, about 0.012-0.013, about 0.013-0.014, about 0.014-0.015, about 0.015-0.016, about 0.016-0.017, about 0.017-0.018, about 0.018-0.019, about 0.019-0.02, about 0.02-0.04, about 0.04-0.06, about 0.06-0.08, about 0.08-0.1, about 0.05, about 0.1, or about 0.01.

In some embodiments, the PEBA has a weight ratio of poly(ethylene oxide) to polyamide of PEBA that is about 0.1-0.5, about 0.5-1, about 1-1.5, about 1.5-2, about 2-3, about 3-4, about 4-5, about 1-2, about 1.2-1.4, about 1.4-1.6, or about 1.5 (60 mg of polyethylene oxide to 40 mg of polyamide is a ratio of 1.5).

In some embodiments, the crosslinker is a PDADMA. PDADMA is also known as PDADMAC or polyDADMAC. In some embodiments, the crosslinker is a combination of PEBAX and PDADMA.

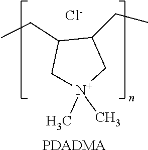

The PDADMA may have any suitable molecular weight, such as less than 100,000 Da, about 200,000-350,000 Da, about 400,000-500,000 Da, about 1-500,000 Da, about 1-200,000 Da, about 200,000-400,000 Da, about 400,000-600,000 Da, about 10,000-500,000 Da, about 10,000-100,000 Da, about 10,000-40,000 Da, about 40,000-70,000 Da, or about 70,000-100,000.

Any suitable amount of a PDADMA may be used. In some embodiments, the ratio of GO to the PDADMA is about 0.005-0.05, (1 mg of GO and 20 mg of the PDADMA is a ratio of 0.05), about 0.005-0.01, about 0.01-0.05, about 0.05-0.1, about 0.1-0.15, about 0.15-0.2, about 0.2-0.25, about 0.25-0.3, about 0.3-0.35, about 0.35-0.4, about 0.02-0.04, about 0.05-0.15, about 0.08-1.2, about 0.15-0.25, about 0.1-0.3, about 0.01-0.03, about 0.01, about 0.02, about 0.033, about 0.05, about 0.1, about 0.2, or about 0.33.

In some embodiments, the crosslinker comprises a PEBA and a PDADMA. Any suitable ratio of the PDADMA to the PEBA may be used, such as about 0.01-0.6 (1 mg of the PDADMA and 100 mg of the PEBA is a ratio of 0.01), about 0.025-0.05, about 0.05-0.1, about 0.1-0.2, about 0.2-0.3, about 0.3-0.4, about 0.4-0.5, about 0.5-0.6, about 0.6-0.7, about 0.7-0.8, about 0.8-0.9, about 0.9-1, about 1-2, about 0.05, about 0.1, about 0.3, about 0.33, about 0.5, or about 1.

In some embodiments, the crosslinker is a PACD. PACD is also known as p(AAm-co-DADMAC).

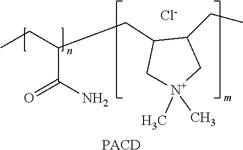

Any suitable amount of a PACD may be used. In some embodiments, the ratio of GO to the PACD is about 0.01-0.05, (1 mg of GO and 20 mg of the PACD is a ratio of 0.05) about 0.05-0.1, about 0.1-0.15, about 0.15-0.2, about 0.2-0.25, about 0.25-0.3, about 0.3-0.35, about 0.35-0.4, about 0.033, or about 0.33.

In some embodiments, the crosslinker comprises a PEBA and PACD. Any suitable ratio of a PACD to a PEBA may be used, such as about 0.01-0.6 (1 mg of PACD and 100 mg of a PEBA is a ratio of 0.01), about 0.01-0.05, about 0.05-0.1, about 0.1-0.2, about 0.2-0.3, about 0.3-0.4, about 0.4-0.5, about 0.5-0.6, about 0.2-0.25, about 0.25-0.3, about 0.3-0.35, about 0.35-0.4, about 0.4-0.45, about 0.45-0.5, about 0.2-0.4, about 0.1-0.5, or about 0.3.

In some embodiments, the crosslinker is a PSS. The PSS may have any suitable molecular weight, such as about 500,000-2,000,000 Da or about 1,000,000 Da.

Any suitable amount of a PSS may be used. In some embodiments, the ratio of GO to the PSS is about 0.01-0.05, (1 mg of GO and 20 mg of the PSS is a ratio of 0.05) about 0.01-0.02, about 0.02-0.03, about 0.03-0.04, about 0.04-0.05, about 0.05-0.1, about 0.1-0.15, about 0.15-0.2, about 0.2-0.25, about 0.25-0.3, about 0.3-0.35, about 0.35-0.4, about 0.033, about 0.05, about 0.1, or about 0.33.

In some embodiments, the crosslinker comprises a PEBA and a PSS. Any suitable ratio of a PSS to a PEBA may be used, such as about 0.01-0.6 (1 mg of a PSS and 100 mg of a PEBA is a ratio of 1), about 0.1-0.2, about 0.2-0.3, about 0.3-0.4, about 0.4-0.5, about 0.5-0.6, about 0.2-0.25, about 0.25-0.3, about 0.3-0.35, about 0.35-0.4, about 0.4-0.45, about 0.45-0.5, about 0.2-0.4, about 0.1-0.5, about 0.3, or about 0.33.

In some embodiments, graphene oxide (GO) is suspended within the crosslinker(s). The moieties of the GO and the crosslinker may be bonded. The bonding may be chemical or physical. The bonding can be direct or indirect; such as in physical communication through at least one other moiety. In some composites, the graphene oxide and the crosslinkers may be chemically bonded to form a network of cross-linkages or a composite material. The bonding also can be physical to form a material matrix, wherein the GO is physically suspended within the crosslinkers.

It is believed that crosslinking the graphene oxide can enhance the GO's mechanical strength and water or water vapor permeable properties by creating strong chemical bonding between the moieties within the composite and wide channels between graphene platelets to allow water or water vapor to pass through the platelets easily. In some embodiments, at least about 1%, at least about 5%, at least about 10%, at least about 20%, at least about 30%, at least about 40% about 50%, at least about 60%, at least about 70%, at least about 80%, at least about 90%, at least about 95%, or all of the graphene oxide platelets may be crosslinked. In some embodiments, the majority of the graphene material may be crosslinked. The amount of crosslinking may be estimated based on the weight of the cross-linker as compared to the total amount of graphene material.

### Additive

An additive or an additive mixture may, in some instances, improve the performance of the composite. Some crosslinked GO-based composites can also comprise an additive mixture. In some embodiments, the additive mixture can comprise calcium chloride, lithium chloride, sodium lauryl sulfate, a lignin, or any combination thereof. In some embodiments, any of the moieties in the additive mixture may also be bonded with the material matrix. The bonding can be physical or chemical (e.g., covalent). The bonding can be direct or indirect.

### Protective Coating

Some membranes may further comprise a protective coating. For example, the protective coating can be disposed on top of the membrane to protect it from the environment. The protective coating may have any composition suitable for protecting a membrane from the environment, Many polymers are suitable for use in a protective coating such as one or a mixture of hydrophilic polymers, e.g. polyvinyl alcohol (PVA), polyvinyl pyrrolidone (PVP), polyethylene glycol (PEG), polyethylene oxide (PEO), polyoxyethylene (POE), polyacrylic acid (PAA), polymethacrylic acid (PMMA) and polyacrylamide (PAM), polyethylenimine (PEI), poly(2-oxazoline), polyethersulfone (PES), methyl cellulose (MC), chitosan, poly (allylamine hydrochloride) (PAH), poly (sodium 4-styrene sulfonate) (PSS), and any combinations thereof. In some embodiments, the protective coating can comprise PVA.

### Methods of Making Dehydration Membranes.

Some embodiments include methods for making a dehydration membrane comprising: (a) mixing the graphene oxide material, the crosslinker comprising a polycarboxylic acid, and the additive in an aqueous mixture to generate a composite coating mixture; (b) applying the coating mixture on a porous support to form a coated support; (c) repeating step (b) as necessary to achieve the desired thickness of coating; and (d) curing the coating at a temperature of about 60-100° C. for about 30 seconds to about 3 hours to facilitate crosslinking within the coated mixture. In some embodiments, the method optionally comprises pre-treating the porous support. In some embodiments, the method optionally further comprises coating the assembly with a protective layer. An example of a possible method embodiment of making an aforementioned membrane is shown in FIG. 2.

In some embodiments, the porous support can be optionally pre-treated to aid in the adhesion of the composite layer to the porous support. In some embodiments, the porous support can be modified to become more hydrophilic. For example, the modification can comprise a corona treatment using 70 W power with 2 counts at a speed of 0.5 m/min.

In some embodiments, applying the mixture to the porous support can be done by methods known in the art for creating a layer of desired thickness. In some embodiments, applying the coating mixture to the substrate can be achieved by vacuum immersing the substrate into the coating mixture first, and then drawing the solution onto the substrate by applying a negative pressure gradient across the substrate until the desired coating thickness can be achieved. In some embodiments, applying the coating mixture to the substrate can be achieved by blade coating, spray coating, dip coating, die coating, or spin coating. In some embodiments, the method can further comprise gently rinsing the substrate with deionized water after each application of the coating mixture to remove excess loose material. In some embodiments, the coating is done such that a composite layer of a desired thickness is created. In some embodiments, the number of layers can range from 1-250, from about 1-100, from 1-50, from 1-20, from 1-15, from 1-10, or 1-5. This process results in a fully coated substrate, or a coated support.

The coating mixture that is applied to the substrate may include a solvent or a solvent mixture, such as an aqueous solvent, e.g. water optionally in combination with a water soluble organic solvent such as an alcohol (e.g. methanol, ethanol, isopropanol, etc.), acetone, etc. In some embodiments, the aqueous solvent mixture contains ethanol and water.

In some embodiments, the porous support is coated at a coating speed that is 0.5-15 meter/min, about 0.5-5 meter/min, about 5-10 meter/min, or about 10-15 meter/min. These coating speeds are particularly suitable for forming a coating layer having a thickness of about 1-3 μm, about 1 μm, about 1-2 μm, or about 2-3 μm.

For some methods, curing the coated support can then be done at temperatures and times sufficient to facilitate crosslinking between the moieties of the aqueous mixture deposited on the porous support. In some embodiments, the coated support can be heated at a temperature of about 60-70° C., about 70-80° C., about 80-90° C., about 90-100° C., or about 80° C. In some embodiments, the coated support can be heated for a duration of at least about 30 seconds, at least about 1 minute, at least about 5 minutes, at least about 6 minutes, at least about 15 minutes, at least about 30 minutes, at least 45 minutes, up to about 1 hour, up to about 1.5 hours, up to about 3 hours; with the time required generally decreasing for increasing temperatures. In some embodiments, the substrate can be heated at about 80° C. for about 8 minutes. This process results in a cured membrane.

In some embodiments, the method for fabricating a membrane can further comprise subsequently applying a protective coating on the membrane. In some embodiments, the applying a protective coating comprises adding a hydrophilic polymer layer. In some embodiments, applying a protective coating comprises coating the membrane with a polyvinyl alcohol aqueous solution. Applying a protective layer can be achieved by methods such as blade coating, spray coating, dip coating, spin coating, and etc. In some embodiments, applying a protective layer can be achieved by dip coating of the membrane in a protective coating solution for about 1-10 minutes, about 1-5 minutes, about 5 minutes, or about 2 minutes. In some embodiments, the method further comprises drying the membrane at a temperature of about 75-120° C. for about 5-15 minutes, or at about 90° C. for about 10 minutes. This process results in a membrane with a protective coating.

### Methods for Reducing Water Vapor Content of a Gas Mixture

A selectively permeable membrane, such as dehydration membrane, described herein may be used in methods for removing water vapor or reducing water vapor content from an unprocessed gas mixture, such as air, containing water vapor, for applications where dry gases or gases with low water vapor content are desired. The method comprises passing a first gas mixture (an unprocessed gas mixture), such as air, containing water vapor through the membrane, whereby the water vapor is allowed to pass through and removed, while other gases in the gas mixture, such as air, are retained to generate a second gas mixture (a dehydrated gas mixture) with reduced water vapor content.

A dehydrating membrane may be incorporated into a device that provides a pressure gradient across the dehydrating membrane so that the gas to be dehydrated (the first gas) has a higher pressure, or a higher partial pressure of water, than that of the water vapor on the opposite side of the dehydrating membrane where the water vapor is received, then removed, resulting in a dehydrated gas (the second gas).

The permeated gas mixture, such as air or a secondary dry sweep stream may be used to optimize the dehydration process. If the membrane were totally efficient in water vapor separation, all the water vapor in the feed stream would be removed, and there would be nothing left to sweep it out of the system. As the process proceeds, the partial pressure of the water vapor on the feed or bore side becomes lower, and the pressure on the shell-side becomes higher. This pressure difference tends to prevent additional water vapor from being expelled from the module. Since the object is to make the bore side dry, the pressure difference interferes with the desired operation of the device. A sweep stream may therefore be used to remove the water vapor from the feed or bore side, in part by absorbing some of the water vapor, and in part by physically pushing the water vapor out.

If a sweep stream is used, it may come from an external dry source or a partial recycle of the product stream of the module. In general, the degree of dehumidification will depend on the pressure ratio of product flow to feed flow (for water vapor across the membrane) and on the product recovery. Good membranes have a high product recovery with low level of product humidity, and/or high volumetric product flow rates.

A dehydration membrane may be used to remove water for energy recovery ventilation (ERV). ERV is the energy recovery process of exchanging the energy contained in normally exhausted building or space air and using it to treat (precondition) the incoming outdoor ventilation air in residential and commercial HVAC systems. During the warmer seasons, an ERV system pre-cools and dehumidifies while humidifying and pre-heating in the cooler seasons.

In some embodiments, the dehydration membrane has a water vapor transmission rate that is at least 500 g/m²/day, at least 1,000 g/m²/day, at least 1,100 g/m²/day, at least 1,200 g/m²/day, at least 1,300 g/m²/day, at least 1,400 g/m²/day, or at least 1,500 g/m²/day as determined by ASTM E96 standard method.

In some embodiments, the dehydration membrane has a water vapor transmission rate that is at least 5000 g/m²/day, at least 10,000 g/m²/day, at least 20,000 g/m²/day, at least 25,000 g/m²/day, at least 30,000 g/m²/day, at least 35,000 g/m²/day, or at least 40,000 g/m²/day as determined by ASTM D-6701 standard method.

In some embodiments, the dehydration membrane has a gas permeance that is less than 0.001 L/(m² Spa), less than 10⁻⁴ L/(m² Spa), less than 10⁻⁵ L/(m² Spa), less than 10⁻⁶ L/(m² Spa), less than 10⁻⁷ L/(m² Spa), less than 10⁻⁸ L/(m² Spa), less than 10⁻⁹ L/(m² Spa), or less than 10⁻¹⁰ L/(m² Spa), as determined by the Differential Pressure Method.

The membranes described herein can be easily made at low cost, and may outperform existing commercial membranes in either volumetric product flow or product recovery.

### EMBODIMENTS

The following embodiments are specifically contemplated.

Embodiment 1. A dehydration membrane comprising:
a porous support; and
a composite coated on the porous support comprising a crosslinked graphene oxide compound,
wherein the crosslinked graphene oxide compound is formed by reacting a mixture comprising 1) a graphene oxide compound, and 2) a polyether block amide (PEBA), a Poly(diallyldimethylammonium chloride)(PDADMA), a poly(acrylamide-co-diallyldimethylammonium chloride)(PACD), a poly(sodium 4-styrenesulfonate)(PSS), or a combination thereof.
   Embodiment 2. The dehydration membrane of embodiment 1, wherein the mixture comprises the PEBA.
   Embodiment 3. The dehydration membrane of embodiment 2, wherein the weight ratio of the graphene oxide compound to the PEBA in the mixture is about 0.005 to about 0.1.
   Embodiment 4. The dehydration membrane of embodiment 2 or 3, wherein the PEBA has a weight ratio of poly(ethylene oxide) to polyamide that is about 1.5.
   Embodiment 5. The dehydration membrane of embodiment 1, 2, 3, or 4, wherein the mixture comprises the PDADMA.
   Embodiment 6. The dehydration membrane of embodiment 5, wherein mixture comprises the PDADMA and the PEBA, and the weight ratio of the PDADMA to the PEBA in the mixture is about 0.01 to about 0.6.
   Embodiment 7. The dehydration membrane of embodiment 5 or 6, wherein the mixture comprises the PDADMA, and the molecular weight of the PDADMA is about 10,000 to about 500,000 Da.
   Embodiment 8. The dehydration membrane of embodiment 5 or 6, wherein the mixture comprises the PDADMA, and the molecular weight of the PDADMA is less than 100,000 Da.
   Embodiment 9. The dehydration membrane of embodiment 1, 2, 3, 4, 5, 6, 7, or 8, wherein the mixture comprises the PACD.
   Embodiment 10. The dehydration membrane of embodiment 9, wherein the mixture comprises the PACD and the PEBA, and the weight ratio of the PACD to the PEBA in the mixture is about 0.2 to about 0.4.
   Embodiment 11. The dehydration membrane of embodiment 1, 2, 3, 4, 5, 6, 7, 8, 9, or 10, wherein the mixture comprises the PSS.
   Embodiment 12. The dehydration membrane of embodiment 11, wherein mixture comprises the PSS and the PEBA, and the weight ratio of the PSS to the PEBA in the mixture is about 0.2 to about 0.4.
   Embodiment 13. The dehydration membrane of embodiment 1, 2, 3, 4, 5, 6, 7, 8, 9, 10, 11, or 12, wherein the composite is a layer that has a thickness of 1 to 3 μm.
   Embodiment 14. The dehydration membrane of embodiment 1, 2, 3, 4, 5, 6, 7, 8, 9, 10, 11, 12, or 13, wherein the membrane has a water vapor transmission rate that is at least 1,000 g/m²/day as determined by ASTM E96 standard method.
   Embodiment 15. The dehydration membrane of embodiment 1, 2, 3, 4, 5, 6, 7, 8, 9, 10, 11, 12, 13, or 14, wherein the membrane has a gas permeance that is less than 0.001 L/m2 s Pa as determined by the Differential Pressure Method.
   Embodiment 16. The dehydration membrane of embodiment 1, 2, 3, 4, 5, 6, 7, 8, 9, 10, 11, or 12, wherein the porous support comprises stretched polypropylene or stretched polyethylene.
   Embodiment 17. A dehydration membrane comprising:
a porous support; and
a composite coated on the porous support comprising a crosslinked graphene oxide compound,
wherein the crosslinked graphene oxide compound is formed by reacting a mixture comprising 1) a graphene oxide compound, and 2) a polyether block amide (PEBA).
   Embodiment 18. The dehydration membrane of claim 17, wherein the porous support comprises polyethylene.
   Embodiment 19. The dehydration membrane of claim 17 or 18, wherein the porous support comprises polypropylene.
   Embodiment 20. The dehydration membrane of claim 19, wherein the porous support comprise stretched polypropylene.
   Embodiment 21. The dehydration membrane of embodiment 1, 2, 3, 4, 5, 6, 7, 8, 9, 10, 11, 12, 13, 14, 15, 16, 17, 18, or 19, wherein the membrane has an antimicrobial activity of 2 or higher according to Japanese Industrial Standard Z 2801:2012.
   Embodiment 22. A method for dehydrating a gas comprising:
applying a first gas to the dehydration membrane of embodiments 1, 2, 3, 4, 5, 6, 7, 8, 9, 10, 11, 12, 13, 14, 15, 16, 17, 18, 19, or 20; and
allowing the water vapor to pass through the dehydration membrane and to be removed; and generating a second gas that has lower water vapor content than the first gas.
   Embodiment 23. A method of making a dehydration membrane comprising:
curing an aqueous mixture that is coated onto a porous support;
wherein the aqueous mixture that is coated onto the porous support is cured at a temperature of 60° C. to 100° C. for about 30 seconds to about 3 hours to facilitate crosslinking within the aqueous mixture;
wherein the porous support is coated with the aqueous mixture by applying the aqueous mixture to the porous support, and repeating as necessary to achieve a layer of coating having a thickness of about 100 nm to about 4000 nm; and
wherein the aqueous mixture is formed by mixing 1) a graphene oxide compound, and 2) a PEBA, a PDADMA, a PACD, a PSS, or a combination thereof, in an aqueous liquid.
   Embodiment 24. A method of making a dehydration membrane of embodiment 1, wherein the aqueous mixture comprises a solvent mixture that contains ethanol and water.
   Embodiment 25. A method of making a dehydration membrane of embodiment 1, wherein the porous support is coated at a coating speed that is 0.5 to 15 meter/min and the resulting coating forms a layer that has a thickness of about 1 μm to about 3 μm.
   Embodiment 26. An energy recovery ventilator system comprising a dehydration membrane of 1, 2, 3, 4, 5, 6, 7, 8, 9, 10, 11, 12, 13, 14, 15, 16, 17, 18, or 19.

### EXAMPLES

It has been discovered that embodiments of the selectively permeable membranes described herein have improved performance as compared to other selectively permeable membranes. These benefits are further demonstrated by the following examples, which are intended to be illustrative of the disclosure only, but are not intended to limit the scope or underlying principles in any way.

### Example 1.1.1: Preparation of a Coating Mixture

Preparation of GO Solution 1: GO was prepared from graphite using the modified Hummers method. Graphite flakes (2.0 g) (Sigma Aldrich, St. Louis, Mo., USA, 100 mesh) were oxidized in a mixture of 2.0 g of NaNO₃ (Aldrich), 10 g KMnO₄ of (Aldrich) and 96 mL of concentrated H₂SO₄ (Aldrich, 98%) at 50° C. for 15 hours. The resulting paste like mixture was poured into 400 g of ice followed by adding 30 mL of hydrogen peroxide (Aldrich, 30%). The resulting solution was then stirred at room temperature for 2 hours to reduce the manganese dioxide, then filtered through a filter paper and washed with DI water. The solid was collected and then dispersed in DI water with stirring, centrifuged at 6300 rpm for 40 minutes, and the aqueous layer was decanted. The remaining solid was then dispersed in DI water again and the washing process was repeated 4 times. The purified GO was then dispersed in 10 mL of DI water under sonication (power of 10 W) for 2.5 hours to get the GO dispersion (0.4 wt %) as GO-1.

The above 0.4 wt % GO dispersion (GO-1) can be further diluted with DI water to give the GO dispersion with 0.1 wt % as GO-2.

### Membrane Preparation Procedure:

A solution was made with a ratio of 1.24 ml of 0.1% GO solution 4.96 ml of 2.5% PEBAX® 1657 solution/0.496 ml of 2.5% PDADMA solution. The solution was shaken well after mixing the solution and confirmed that there was no GO chunks, then degassed for 7 minutes with an ultrasonic cleaner. The coating solution was applied on the freshly cleaned stretched polypropylene substrate, with 150 μm wet gap. The resulting membrane was dried then cured at 80° C. for 8 min.

Other coating mixtures or coating solutions were made in a manner similar to GO/PEBAX except that different polymers or additives were utilized in addition to PEBAX, such as a PDADMA, a PACD, a PSS, poly(acrylic acid) (PAA), poly(vinyl alcohol) (PVA), sodium lignosulfonate (LSU), sodium lauryl sulfate (SLS), etc., and with different weight ratios as shown in Table 1.

### Example 3.1.1: Measurement of Selectively Permeable Membranes

Membranes of EX-1, EX-2, EX-3, EX-4, EX-5, EX-6, EX-7, and EX-8 were tested for water vapor transmission rate (WVTR) as described in ASTM E96 standard method, at a temperature of 20° C. and 50% relative humidity (RH), and/or for N₂ permeance. The results are shown in Table 1.

TABLE 1

| | | | | | | WVTR | | |
|---|---|---|---|---|---|---|---|---|
| | | | | WVTR | | (20° C., | Gas | |
| | | | | (20° C., | Gas | 50% RH) | permeance | |
| | | | Thick- | 50% RH) | permeance | Aft. 24 h 50° C. | | ΔWVTR |
| | | | ness | Before Soaking | | water soak | | (after |
| | Composition | Ratio | (um) | g/m²/day | L/(m² SPa) | g/m²/day | L/(m² SPa) | soaking) |
| | PEBAX | 100 | 2 | 1450 | 5.0E−7 | | | |
| EX-1 | GO/PEBAX | 1/100 | 2 | 1450 | 4.3E−9 | 1455 | 5E−9 | 0.3% |
| EX-2 | GO/PEBAX/ | 1/100/30 | 2 | 1478 | 8.6E−9 | 1534 | 4.3E−7 | +4% |
| | PDADMA, | | | | | | | |
| | (Mw < 100 k) | | | | | | | |
| EX-3 | GO/PEBAX/ | 1/100/10 | 2 | 1461 | | 1476.4 | | +1% |
| | PDADMA, | | | | | | | |
| | (Mw < 100 k) | | | | | | | |
| EX-4 | GO/PEBAX/ | 1/100/5 | 2 | 1404 | | 1539 | | +10% |
| | PDADMA, | | | | | | | |
| | (Mw < 100 k) | | | | | | | |
| EX-5 | GO/PEBAX/ | 1/100/10 | 2 | 1323 | | 1510 | | +14% |
| | PDADMA, | | | | | | | |
| | (Mw: 200 to | | | | | | | |
| | 350 K) | | | | | | | |
| EX-6 | GO/PEBAX/ | 1/100/10 | 2 | 1491 | 3.3E−8 | 1462 | 1.5E−9 | −2% |
| | PDADMA, | | | | | | | |
| | (Mw: 400 to | | | | | | | |
| | 500 K) | | | | | | | |
| EX-7 | GO/PEBAX/ | 1/100/30 | 2 | 1472 | 6.4E−8 | 1595.4 | 2.8E−9 | +8% |
| | P(AAm-co- | | | | | | | |
| | DADMAC) | | | | | | | |
| EX-8 | GO/PEBAX/ | 1/100/30 | 2 | 1554 | 2E−10 | 1542 | 4 × E−09 | −0.8% |
| | PSS | | | | | | | |

Note:
PSS: Poly(sodium 4-styrenesulfonate);
PDADMA: Poly(diallyldimethylammonium chloride);
P(AAm-co-DADMAC): poly(acrylamide-co- diallyldimethylammonium chloride);
PEBAX: polyether block amide.

The WVTR of membranes were also measured using MOCON Permatran 101K instrument with ASTM D-6701 standard at 37.8° C., 100% RH condition. The results are shown in Table 2.

TABLE 2

| | | | | WVTR |
|---|---|---|---|---|
| | | | | (37.8° C, |
| | | | Thickness | 100% RH) |
| | Composition | Ratio | (um) | g/m²/day |
| EX-1 | GO/PEBAX | 1/100 | 2 | 41,380 |
| EX-2 | GO/PEBAX/PDADMA, | 1/100/30 | 2 | 44,530 |
| | (Mw < 100 k) | | | |
| EX-3 | GO/PEBAX/PDADMA, | 1/100/10 | 2 | 33,200 |
| | (Mw < 100 k) | | | |
| EX-4 | GO/PEBAX/PDADMA, | 1/100/5 | 2 | 22,245 |
| | (Mw < 100 k) | | | |
| EX-9 | GO/PEBAX/PDADMA, | 1/100/50 | 2 | 44,325 |
| | (Mw < 100 k) | | | |
| EX-10 | GO/PEBAX/PDADMA, | 1/100/30 | 2 | 34,377 |
| | (Mw: 400 to 500 K) | | | |
| EX-11 | GO/PEBAX/PDADMA, | 1/100/100 | 2 | 45,236 |
| | (Mw: 400 to 500 K) | | | |

Note:
PEBAX: polyether block amide;
PDADMA: Poly(diallyldimethylammonium chloride).

Membranes of EX-12, EX-13, EX-14, EX-15, and EX-16 were prepared in the same manner as EX-1 on various substrates. Their WVTR performance were evaluated using both ASTM E96 and ASTM D-6701 standard methods as shown in Table 3. The EX-1 with stretched polypropylene as substrate has the highest WVTR performance.

TABLE 3

| | | | | | WVTR [g/m²/day] | | |
|---|---|---|---|---|---|---|---|
| | | | | | ASTM | ASTM | |
| | | | | Thick- | E96 | D-6701 | Gas (N2) |
| | | | | ness | (20° C., | (37.8° C., | Permeance |
| | Composition | Substrate | Ratio | (um) | 50% RH) | 100% RH) | (L/(m²s Pa) |
| EX-1 | GO/PEBAX | Stretched | 1/100 | 2 | 1450 | 41,380 | 1.0E−9 |
| | | polypropylene | | | | | |
| EX-12 | GO/PEBAX | PV400 (PVDF) | 1/100 | 2 | 1270 | 31,000 | 2.7E−9 |
| EX-13 | GO/PEBAX | PA200 (PAN) | 1/100 | 2 | 1090 | 23,000 | 8.7E−9 |
| EX-14 | GO/PEBAX | Nylon (0.1 um) | 1/100 | 2 | 1200 | 9,000 | 9.7E−10 |
| EX-15 | GO/PEBAX | PES 0.1 um | 1/100 | 2 | 1340 | 28,000 | 2.7E−9 |
| EX-16 | GO/PEBAX | Cellulose Acetate | 1/100 | 2 | 1254 | 33,000 | 6.0E−6 |

Note:
PEBAX: polyether block amide.

### Example 3.1.2. Measurement of Membrane Antimicrobial Activities

To test the membrane anti-microbial, example AM-1 was measured using a procedure that conformed to Japanese Industrial Standard (JIS) Z 2801:2012 (English Version pub. September 2012) for testing anti-microbial product efficacy, which is incorporated herein in its entirety. The organisms used in the verification of antimicrobial capabilities were Escherichia coli. (ATCC® 8739, ATCC).

For the test, a broth was prepared by suspending 8 g of the nutrient powder (Difco™ Nutrient Broth, Becton, Dickinson and Company, Franklin Lakes, N.J. USA) in 1 L of filtered, sterile water, mixing thoroughly and then heating with frequent agitation. To dissolve the powder the mixture was boiled for 1 minute and then autoclaved at 121° C. for 15 minutes. The night before testing, the Escherichia coli. were added to 2-3 mL of the prepared broth and grown overnight.

On the day of the test, the resulting culture was diluted in fresh media and then allowed to grow to a density of 10⁸ CFU/mL (or approximately diluting 1 mL of culture into 9 mL of fresh nutrient broth). The resulting solution was then left to re-grow for 2 hours. The re-growth was then diluted by 50 times in sterile saline (NaCl 8.5 g (Aldrich) in 1 L of distilled water) to achieve an expected density of about 1×10⁶ CFU/mL. 50 μL of the dilute provides the inoculation number.

The samples were then cut into 1 inch by 2 inch squares and placed in a petri dish with the GO-coated side up. Then 50 μL of the dilute was taken and the test specimens were inoculated. A transparent cover film (0.75 in.×1.5 in., 3M, St. Paul, Minn. USA) was then used to help spread the bacterial inoculums, define the spread size, and reduce evaporation. Then, the petri dish was covered with a transparent lid, and left so the bacteria could grow.

When the desired measurement points of 2 hours and 24 hours were achieved, the test specimens and cover film were transferred with sterile forceps into 50 mL conical tubes with 20 mL of saline and the bacteria for each sample was washed off by mixing them for at least 30 seconds in a vortex mixer (120V, VWR Arlington Heights, Ill. USA). The bacteria cells in each solution were then individually transferred using a pump (MXPPUMP01, EMD Millipore, Billerica, Mass. USA) combined with a filter (Millflex-100, 100 mL, 0.45 μm, white gridded, MXHAWG124, EMD Millipore) into individual cassettes prefilled with tryptic soy agar (MXSMCTS48, EMD Millipore).

Then the cassettes were inverted and placed in an incubator at 37° C. for 24 hours. After 24 hours, the number of colonies on the cassettes was counted. If there were no colonies a zero was recorded. For untreated pieces, after 24 hours the number of colonies was not less than 1×10³ colonies.

The results of the test bacterium are presented in Table 4. The organism count was ^{˜}100 times lower in the experimental sample AM-1 than the control samples (CM-1). This data supports an antibacterial activity of 2.0 or higher. As a result, it was determined that the GO/PEBAX/PDADMA coating, AM-1, is an effective biocide that could help prevent microbe buildup on surfaces.

TABLE 4
Antimicrobial Activities of Membranes

| | | E. Coli count (cfu) aft 24 hr incubation | |
|---|---|---|---|
| | | Initial count: 5.7E+05 cfu | |
| Composition | Ratio | Aft × 10³ dilution | Aft × 10⁴ dilution |
| GO/PEBAX (CM-1) | 1/100 | TNTC | 137 |
| GO/PEBAX/PDADMA | 1/100/30 | 38 | 1 |
| (Mw < 100 K) (AM-1) | | | |
| GO/PEBAX/PDADMA | 1/100/50 | 112 | 7 |
| (Mw < 100 K) (AM-2) | | | |
| GO/PEBAX/PDADMA | 1/100/30 | 139 | 11 |
| (Mw ~ 400 K (AM-3) | | | |

Note:
PEBAX: polyether block amide;
PDADMA: Poly(diallyldimethylammonium chloride).

Unless otherwise indicated, all numbers expressing quantities of ingredients, properties such as molecular weight, reaction conditions, and etc. used in herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sought to be achieved, and should, therefore, be considered as part of the disclosure. At the very least, the examples shown herein are for illustration only, not as an attempt to limit the scope of the disclosure.

The terms “a,” “an,” “the” and similar referents used in the context of describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any claim. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variations on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A dehydration membrane comprising:
a porous support; and
a composite coated on the porous support comprising a crosslinked graphene oxide compound, wherein the crosslinked graphene oxide compound is formed by reacting a mixture comprising 1) a graphene oxide compound, and 2) a polyether block amide (PEBA), a poly(diallyldimethylammonium chloride)(PDADMA), a poly(acrylamide-co-diallyldimethylammonium chloride)(PACD), a poly(sodium 4-styrenesulfonate)(PSS), or a combination thereof.

2. The dehydration membrane of claim 1, wherein the mixture comprises the PEBA.

3. The dehydration membrane of claim 2, wherein the weight ratio of the graphene oxide compound to the PEBA in the mixture is about 0.005 to about 0.1.

4. The dehydration membrane of claim 2, wherein the PEBA has a weight ratio of poly(ethylene oxide) to polyamide that is about 1.5.

5. The dehydration membrane of claim 1, wherein the mixture comprises the PDADMA.

6. The dehydration membrane of claim 5, wherein mixture comprises the PDADMA and the PEBA, and the weight ratio of the PDADMA to the PEBA in the mixture is about 0.01 to about 0.6.

7. The dehydration membrane of claim 5, wherein the molecular weight of the PDADMA is less than 100,000 Da.

8. The dehydration membrane of claim 1, wherein the mixture comprises the PACD.

9. The dehydration membrane of claim 1, wherein the mixture comprises the PACD and the PEBA, and the weight ratio of the PACD to the PEBA in the mixture is about 0.2 to about 0.4.

10. The dehydration membrane of claim 1, wherein the mixture comprises the PSS.

11. The dehydration membrane of claim 1, wherein mixture comprises the PSS and the PEBA, and the weight ratio of the PSS to the PEBA in the mixture is about 0.2 to about 0.4.

12. The dehydration membrane of claim 1, wherein the composite is a layer that has a thickness of 1 to 3 μm.

13. The dehydration membrane of claim 1, wherein the membrane has a water vapor transmission rate that is at least 1,000 g/m²/day as determined by ASTM E96 standard method.

14. The dehydration membrane of claim 1, wherein the membrane has a gas permeance that is less than 0.001 L/m² s Pa as determined by the Differential Pressure Method.

15. The dehydration membrane of claim 1, wherein the porous support comprises polypropylene, stretched polypropylene, polyethylene, or stretched polyethylene.

16. The dehydration membrane of claim 1, wherein the membrane has an antimicrobial activity of 2 or higher according to Japanese Industrial Standard Z 2801:2012.

17. A method for dehydrating a gas comprising:
applying a first gas to the dehydration membrane of claim 1; and
allowing the water vapor to pass through the dehydration membrane and to be removed; and generating a second gas that has lower water vapor content than the first gas.

18. A method of making a dehydration membrane comprising:
curing an aqueous mixture that is coated onto a porous support;
wherein the aqueous mixture that is coated onto the porous support is cured at a temperature of 60° C. to 100° C. for about 30 seconds to about 3 hours to facilitate crosslinking within the aqueous mixture;
wherein the porous support is coated with the aqueous mixture by applying the aqueous mixture to the porous support, and repeating as necessary to achieve a layer of coating having a thickness of about 100 nm to about 4000 nm; and
wherein the aqueous mixture is formed by mixing 1) a graphene oxide compound, and 2) a PEBA, a PDADMA, a PACD, a PSS, or a combination thereof, in an aqueous liquid; and
the aqueous liquid comprises a solvent mixture that contains ethanol and water.

19. The method of claim 18, wherein the porous support is coated at a coating speed that is 0.5 to 15 meter/min and the resulting coating forms a layer that has a thickness of about 1 μm to about 3 μm.

20. An energy recovery ventilator system comprising a dehydration membrane of claim 1.
